(19) United States
(12) Patent Application Publication
(10) Pub. No.: US 2013/0127920 A1
(43) Pub. Date: May 23, 2013

(54) Focusing on Contextually-Relevant Content

(71) Applicants: Stav Grinshpon, Petach Tikva (IL); Nimrod Barak, Tel Aviv (IL); David Kviti, Tel Aviv (IL)

(72) Inventors: Stav Grinshpon, Petach Tikva (IL); Nimrod Barak, Tel Aviv (IL); David Kviti, Tel Aviv (IL)

(73) Assignee: SAP Portals Israel Ltd., Raanana (IL)

(21) Appl. No.: 13/301,971

(22) Filed: Nov. 22, 2011

(51) Int. Cl. G09G 5/00; G06F 17/30

(52) U.S. Cl. 345/661; 707/723; 707/E17.014

(57) ABSTRACT

Implementations of the present disclosure include a method, system, apparatus, and storage media for matching data associated with a user with one or more respective attributes of a plurality of sub-portions of web content, each of the plurality of sub-portions of web content including at least one attribute; ranking the plurality of sub-portions of web content based on matching the data associated with the user with the one or more respective attributes of the plurality of sub-portions of web content; and focusing the graphical user interface of the mobile communication device on a highest-ranked sub-portion of web content in the ranked plurality of sub-portions.

### TECHNICAL BACKGROUND

This disclosure relates to focusing on contextually-relevant content in a graphical user interface.

### BACKGROUND

Business users of software in a business enterprise may access a virtual workspace through a portal to browse, view, modify, and/or otherwise manipulate data related to the business enterprise. Such data may include a variety of information in many different forms, such as sales data, revenue data, human resources information, business hierarchy information, and otherwise. Graphs, tables, charts, electronic communications, web services, reports, and other forms of data, may be viewable in the user's workspace. The workspace may allow or facilitate the resolution of business issues and/or problems by the user. Contextual information, however, may enable the user to identify relationships between existing modules active in the workspace, relationships between active modules and additional data related to the business enterprise, and, generally, enrich the workspace context.

In some instances, business users may access the virtual workspace (or other workspace, website, or other content) through the portal from a mobile device (e.g., smartphone, PDA, tablet, cell phone, or other mobile communication device). In some instances, for example when the portal exposes large amounts of web content, mechanisms for orienting such content on the mobile device may be desirable. For instance, mobile devices may have less display area due to, for example, the smaller display screen size as compared to desktop and/or laptop computers (e.g., computing devices not generally thought of as mobile communication devices). Thus, effective use of the smaller display screen size may be important to the business user while minimizing the necessity for hidden commands and scrolling.

### SUMMARY

This disclosure describes systems, methods, apparatus, and computer-readable media for focusing portions of a web portal based on user data that is displayed by a mobile communications device. The web content includes a plurality of sub-portions of web content each having associated attributes. The sub-portions of web content can be matched to a user of the web portal based on matching the user data of the user with the attributes of the sub-portions of web content. The matched sub-portions of web content can be ranked, and a graphical user interface (GUI) of the mobile communications device can be focused on a highest-ranked sub-portion of web content. In some implementations, the GUI can be zoomed on the highest-ranked sub-portion of web content.

In one general embodiment, a method performed with a computing system for managing content on a mobile communication device includes matching data associated with a user with one or more respective attributes of a plurality of sub-portions of web content, each of the plurality of sub-portions of web content including at least one attribute; ranking the plurality of sub-portions of web content based on matching the data associated with the user with the one or more respective attributes of the plurality of sub-portions of web content; and focusing the graphical user interface of the mobile communication device on a highest-ranked sub-portion of web content in the ranked plurality of sub-portions. Other embodiments include corresponding systems, apparatus, computer programs, and tangible, non-transitory storage media.

In a first aspect combinable with the general embodiment, ranking the plurality of sub-portions of web content from a highest-ranked sub-portion of web content to a lowest-ranked sub-portion of web content.

A second aspect combinable with any of the previous aspects includes identifying metadata associated with the related user data.

In a third aspect combinable with any of the previous aspects, the respective attributes of the plurality of sub-portions of web content include respective metadata associated with each of the plurality of sub-portions of web content.

In a fourth aspect combinable with any of the previous aspects, matching the identified data associated with the user with one or more respective attributes of the plurality of sub-portions of web content includes matching the identified metadata associated with the related user data with the metadata associated with each of the plurality of sub-portions of web content.

In a fifth aspect combinable with any of the previous aspects, each of the plurality of sub-portions of web content include a self-contained Web document referenced by a Uniform Resource Locator (URL).

A sixth aspect combinable with any of the previous aspects includes zooming the graphical user interface to enlarge the highest-ranked sub-portion of web content.

A seventh aspect combinable with any of the previous aspects includes retrieving size characteristics of the graphical user interface.

An eighth aspect combinable with any of the previous aspects includes retrieving size characteristics of the highest-ranked sub-portion of web content.

A ninth aspect combinable with any of the previous aspects includes adjusting a display size of the highest-ranked sub-portion of web content based, at least in part, on the size characteristics of the graphical user interface and the size characteristics of the highest-ranked sub-portion of web content.

A tenth aspect combinable with any of the previous aspects includes retrieving size characteristics of the exposed web content.

An eleventh aspect combinable with any of the previous aspects includes adjusting the display size of the highest-ranked sub-portion of web content based, at least in part, on the size characteristics of the graphical user interface, the size characteristics of the highest-ranked sub-portion of web content, and the size characteristics of the exposed web content.

A twelfth aspect combinable with any of the previous aspects includes retrieving a browser width of the graphical user interface and a browser height of the graphical user interface.

In a thirteenth aspect combinable with any of the previous aspects, retrieving size characteristics of the highest-ranked sub-portion of web content comprises retrieving a sub-portion width and a sub-portion height.

A fourteenth aspect combinable with any of the previous aspects includes comparing values for the browser width, the browser height, the sub-portion width, and the sub-portion height.

A fifteenth aspect combinable with any of the previous aspects includes determining the smallest value of the compared values.

A sixteenth aspect combinable with any of the previous aspects includes adjusting the display size of the highest-ranked sub-portion of web content based, at least in part, on the determined smallest value.

A seventeenth aspect combinable with any of the previous aspects includes exposing the web content through a graphical user interface of a mobile communication device.

In an eighteenth aspect combinable with any of the previous aspects, the exposed web content includes the plurality of sub-portions of web content exposed through a portal.

A nineteenth aspect combinable with any of the previous aspects includes identifying the data associated with the user.

Various embodiments of a content focus module according to the present disclosure may have one or more of the following features. For example, the content focus module may, based on user information, focus the most important information of web content to the user, using dynamic page zooming while staying in the portals context. Further advantages include providing all or most of the portal services menus on the screen; providing zooming capabilities without any restriction on the content type zoomed to consistently preserve the portal menus proportions and look and feel. Further, user information such as history and preferences is stored according to the content consumed by the users, or according to portal specific data (such as their assigned portal roles in the portal repository). This content may assist in ranking content parts in any page delivered to the user's client. The top ranked content parts may then be emphasized within the page so that user can quickly access the content most relevant to the user.

These general and specific aspects may be implemented using a device, system or method, or any combinations of devices, systems, or methods. The details of one or more implementations are set forth in the accompanying drawings and the description below. Other features, objects, and advantages will be apparent from the description and drawings, and from the claims.

### DESCRIPTION OF DRAWINGS

FIG. 1 illustrates an example distributed computing system operable to focus on contextually-relevant content in a mobile communication device according to the present disclosure;

FIG. 2 illustrates an example mobile communication device displaying web content according to the present disclosure;

FIG. 3 illustrates an example method for determining and focusing on contextually-relevant content in a mobile communication device according to the present disclosure;

FIG. 4 illustrates an example mobile communication device displaying focused web content according to the present disclosure;

FIG. 5 illustrates an example method for focusing on contextually-relevant content in a mobile communication device according to the present disclosure; and

FIG. 6 illustrates example instructions for focusing on contextually-relevant content in a mobile communication device according to the present disclosure.

### DETAILED DESCRIPTION

This specification describes systems, methods, apparatus, and computer-readable media for focusing portions of a web portal based on user data that is displayed by a mobile communications device. The web content includes a plurality of sub-portions of web content each having associated attributes. The sub-portions of web content can be matched to a user of the web portal based on matching the user data of the user with the attributes of the sub-portions of web content. The matched sub-portions of web content can be ranked, and a graphical user interface (GUI) of the mobile communications device can be focused on a highest-ranked sub-portion of web content. In some implementations, the GUI can be zoomed on the highest-ranked sub-portion of web content.

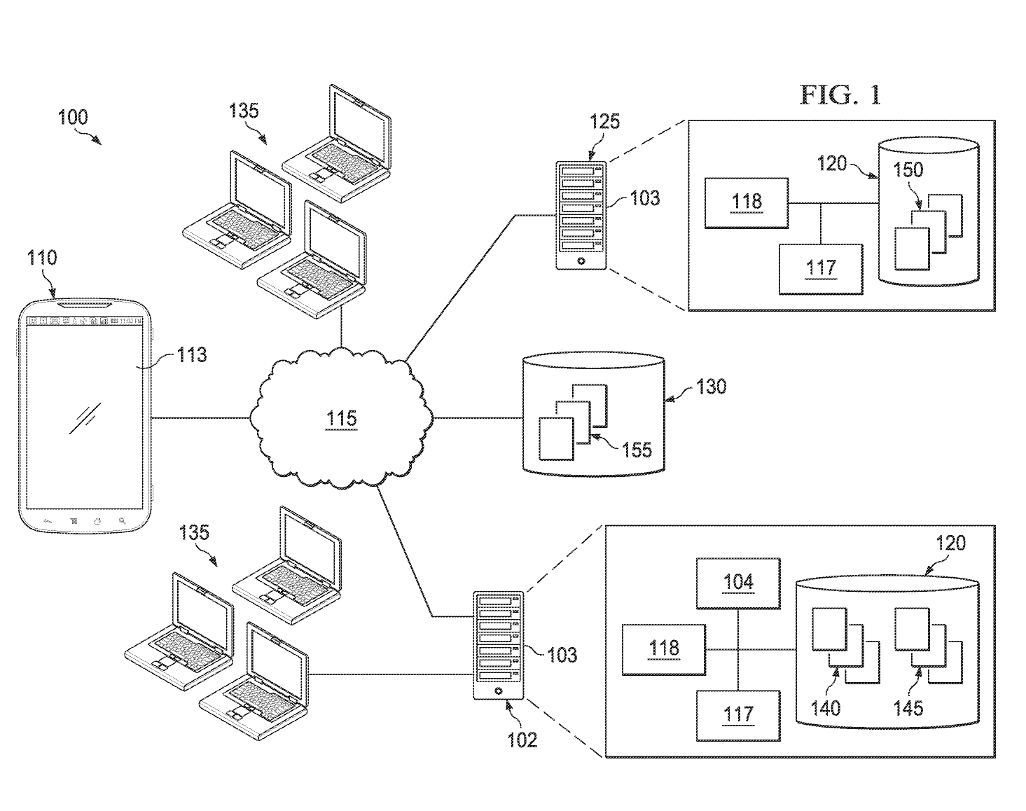

FIG. 1 illustrates an example distributed computing system 100 operable to focus on contextually-relevant content in a mobile communication device 110. Specifically, the illustrated environment 100 includes or is communicably coupled with an enterprise computing system 102, a software provider computing system 125, a repository 130, one or more client computing devices 135 (“clients”), and the mobile communication device 110 (“mobile device”), at least some of which communicate across a network 115.

The enterprise computing system 102 and the software provider computing system 125 both include servers 103. In general, the server 103 is any server that stores one or more hosted applications, where at least a portion of the hosted applications are executed via requests and responses sent to users or clients within and communicably coupled to the illustrated environment 100 of FIG. 1. In some instances, the server 103 may store a plurality of various hosted applications, while in other instances, the server 103 may be a dedicated server meant to store and execute only a single hosted application. In some instances, the server 103 may comprise a web server, where the hosted applications represent one or more web-based applications accessed and executed via network by the clients 135 or the mobile device 110 to perform the programmed tasks or operations of the hosted application.

At a high level, the server 103 comprises an electronic computing device operable to receive, transmit, process, store, or manage data and information associated with the environment 100. Specifically, the server 103 illustrated in FIG. 1 is responsible for receiving application requests from one or more client applications associated with the clients 135 or the mobile device 110 of environment 100 and responding to the received requests by processing said requests in the associated hosted application, and sending the appropriate response from the hosted application back to the requesting client application. In addition to requests from the clients 135 and the mobile device 110 illustrated in FIG. 1, requests associated with the hosted applications may also be sent from internal users, external or third-party customers, other automated applications, as well as any other appropriate entities, individuals, systems, or computers.

As used in the present disclosure, the term “computer” is intended to encompass any suitable processing device. For example, although FIG. 1 illustrates a single server 103, environment 100 can be implemented using two or more servers 103, as well as computers other than servers, including a server pool. Indeed, server 103 may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, illustrated server 103 may be adapted to execute any operating system, including Linux, UNIX, Windows, Mac OS, or any other suitable operating system. According to one embodiment, server 103 may also include or be communicably coupled with a mail server.

The server 103 of the enterprise computing system 102 includes a content focus module 104. The content focus module 104 focuses web content, and specifically, contextually-relevant content of the web content in a graphical user interface of the mobile device 110, described further below. In short, the content focus module 104 is able to identify data relating to a user of a web portal exposed on the mobile device 110, match the identified data with sub-portions of web content of the web portal, rank the sub-portions of web content, and focus a graphical user interface 113 of the mobile device 110 on a highest-ranked sub-portion of web content. The content focus module 104 can be implemented by and stored by any combination of the enterprise computing system 102, the software providing computer system 125, the repository 130, the clients 135, and the mobile device 100.

The illustrated servers 103 further include an interface 117, a processor 118, and a memory 120. The interface 117 is used by the server 103 for communicating with other systems in a distributed environment (including within the environment 100) connected to the network 115 (e.g., the clients 135 or the mobile device 110, as well as other systems communicably coupled to the network 115). Generally, the interface 117 comprises logic encoded in software and/or hardware in a suitable combination and operable to communicate with the network 115. More specifically, the interface 117 may comprise software supporting one or more communication protocols associated with communications such that the network 115 or interface's hardware is operable to communicate physical signals within and outside of the illustrated environment 100.

As illustrated in FIG. 1, the servers 103 include a processor 118. Although illustrated as a single processor 118 in FIG. 1, two or more processors may be used according to particular needs, desires, or particular embodiments of the environment 100. Each processor 118 may be a central processing unit (CPU), a blade, an application specific integrated circuit (ASIC), a field-programmable gate array (FPGA), or another suitable component. Generally, the processor 118 executes instructions and manipulates data to perform the operations of the server 103. Specifically, the processor 118 executes the functionality required to receive and respond to requests from the clients 135 and/or the mobile device 110.

Regardless of the particular implementation, “software” may include computer-readable instructions, firmware, wired or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java, Visual Basic, assembler, Perl, any suitable version of 4GL, as well as others. While portions of the software illustrated in FIG. 1 are shown as individual modules that implement the various features and functionality through various objects, methods, or other processes, the software may instead include a number of sub-modules, third party services, components, libraries, and such, as appropriate. Conversely, the features and functionality of various components can be combined into single components as appropriate.

The servers 103 also include a memory 120. The memory 120 may include any memory or database module and may take the form of volatile or non-volatile memory including, without limitation, magnetic media, optical media, random access memory (RAM), read-only memory (ROM), removable media, or any other suitable local or remote memory component. The memory 120 may store various objects or data, including classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the computing system 102, 125. Additionally, the memory 120 may include any other appropriate data, such as VPN applications, firmware logs and policies, firewall policies, a security or access log, print or other reporting files, as well as others.

The environment further includes repository 130, the repository 130 can be a cloud-based storage medium. For example, the repository 130 can be networked online storage where data is stored on virtualized pools of storage.

The illustrated environment of FIG. 1 also includes one or more clients 135 and the mobile device 110. Each client 135 and/or the mobile device 110 may be any computing device operable to connect to or communicate with at least the computing systems 102, 125 and/or via the network 115 using a wireline or wireless connection. In general, each client 135 and/or the mobile device 110 comprises an electronic computer device operable to receive, transmit, process, and store any appropriate data associated with the environment 100 of FIG. 1.

There may be any number of clients 135 and/or mobile devices 110 associated with, or external to, the environment 100. For example, while the illustrated environment 100 includes six clients 135 and one mobile device 110, alternative implementations of environment 100 may include a single client 135 or multiple mobile devices 110 communicably coupled to the server 102 and/or the network 115, or any other number suitable to the purposes of the environment 100.

Additionally, there may also be one or more additional clients 135 and/or mobile devices 110 external to the illustrated portion of environment 100 that are capable of interacting with the environment 100 via the network 115. Further, the term “client” and “user” may be used interchangeably as appropriate without departing from the scope of this disclosure. Moreover, while each client 135 and/or the mobile device 110 is described in terms of being used by a single user, this disclosure contemplates that many users may use one computer, or that one user may use multiple computers. As used in this disclosure, the client 135 is intended to encompass a personal computer, touch screen terminal, workstation, network computer, kiosk, one or more processors within these or other devices, or any other suitable processing device.

The illustrated mobile device 110 is intended to encompass any mobile computing device such as a wireless data port, smart phone, personal data assistant (PDA), tablet computing device, one or more processors within these devices, or any other suitable processing device. For example, each client 135 and the mobile device 110 may comprise a computer that includes an input device, such as a keypad, touch screen, mouse (in the client 135 example), or other device that can accept user information, and an output device that conveys information associated with the operation of the computing systems 102, 125 or the client 135 or the mobile device 100 itself, including digital data, visual information, or a graphic user interface (GUI) 113, as shown with respect to the mobile device 110. In the example of the clients 135, both the input and output device may include fixed or removable storage media such as a magnetic storage media, CD-ROM, or other suitable media to both receive input from and provide output to users of the clients 135 through the display.

Further, the mobile device 110 includes the GUI 113 to interface with at least a portion of the environment 100 for any suitable purpose, including generating a visual representation of a web browser. Generally, through the GUI 113, the user is provided with an efficient and user-friendly presentation of data provided by or communicated within the system. The term “graphical user interface,” or GUI, may be used in the singular or the plural to describe one or more graphical user interfaces and each of the displays of a particular graphical user interface. Therefore, the GUI 113 can represent any graphical user interface, including but not limited to, a web browser, touch screen, or command line interface (CLI) that processes information in the environment 100 and efficiently presents the information results to the user. In general, the GUI 113 may include a plurality of user interface (UI) elements, some or all associated with a web browser, such as interactive fields, pull-down lists, and buttons operable by the user at the mobile device 113. These and other UI elements may be related to or represent the functions of the web browser. In particular, the GUI 113 may be used to view and navigate various web pages located both internal and external to the server.

The environment 100 further includes user data 140, web content 150 and 155, and sub-portions of web content 145. The user data 140 can include user personal data, user history, and collaboration data. The user personal data may include a profile associated with users describing personal and employment data. The user history may include user navigation actions that can be used to create interest maps for each user. The collaboration data includes user interactions in collaboration scenarios that provide relevant information, e.g., content uploaded to collaborative spaces, interests, and organizational relation of members. As illustrated, the user data 140 is stored by the memory 120 of the enterprise computing system 102. However, the user data 140 can be stored in any combination of the memory of the mobile device 110, the enterprise computing system 102, the software provider service computing system 125, the repository 130, and/or the clients 135. In some implementations, the user data 140 is stored by a third party that provides networked online storage.

The web content 150, 155 is the textual, visual or aural content that is encountered as part of the user experience on websites. The web content 150, 155 may include, among other things: text, images, sounds, videos and animations. The web content is stored by any combination of the software provider service computing system 125 and the repository 130.

The sub-portions of web content 145 are any kind of application, information, or service that can be visualized in a Web browser frame. The sub-portions of web content 145, in some embodiments, may be self-contained Web documents that are provided via a Uniform Resource Locator (URL) that are managed by the enterprise computing system 102. For example, the sub-portions of web content 145 can include alerts, reports, email, calendar, and other content. For example, if a user enters a word in a dictionary web content sub-portion 145, the definition appears inside the area of the sub-portion of web content 145. A link to usage examples, similar words, etc. can also be provided.

The sub-portions of web content 145 can include one or more of the characteristics of: stateless (not permanently connected to any component of the environment 100); embedded (non-dominant, parallel to other sub-portions of web content 145); provide previews on underlying processes and/or data; one-screen interactions; include only key functionality; provide direct access without navigation; push information and refresh periodically; integration with third-party software; and allow users to modify an appearance thereof. The sub-portions of web content 145 may provide data, for example, providing active information; monitor business processes; preview data and processes; display notifications for starting task-related processes; and offering access to often used data. The sub-portions of web content 145 may further provide direct access to simple applications; accelerated access to other applications; reduction of information and interaction to the necessary; and drag-and-relate that use outputs as inputs within the environment 100. The sub-portions of web content 145 offer customization such that specific sub-portions of web content 145, along with reduction of information and tailoring of information presented by the sub-portions of web content 145, can be implemented according to the user data 140.

As illustrated, the sub-portions of web content 145 are stored by the memory 120 of the enterprise computing system 102. However, the sub-portions of web content 145 can be stored in any combination of the memory the enterprise computing system 102, the software provider service computing system 125, and/or the repository 130.

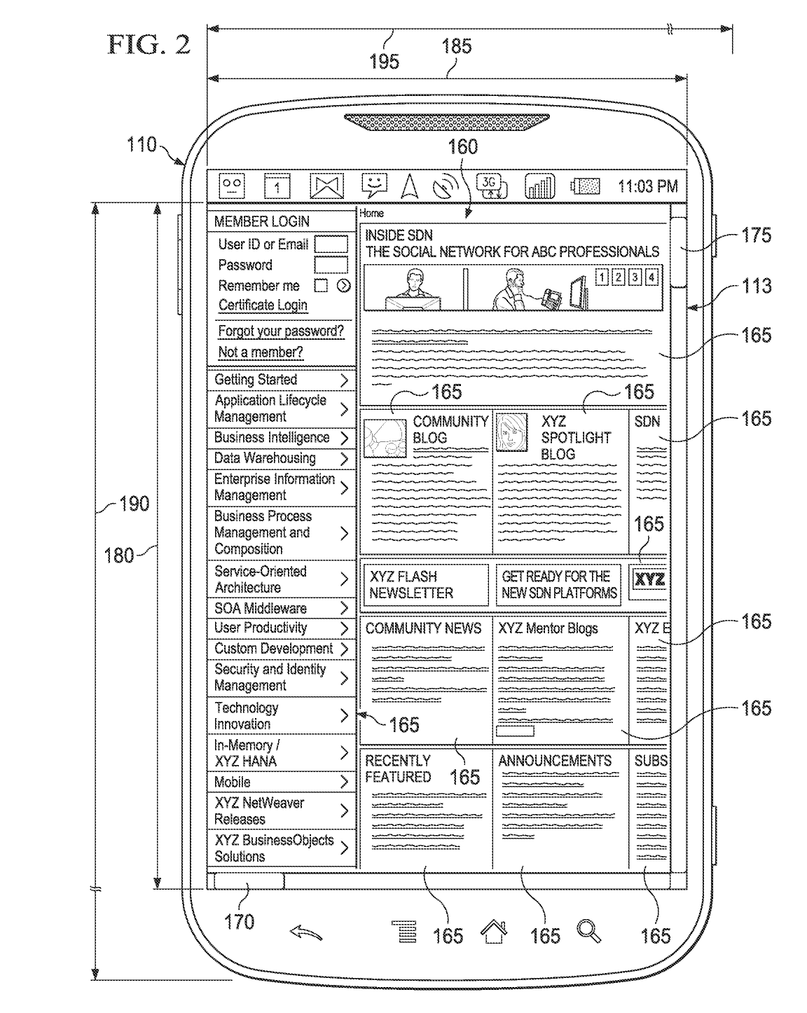

FIG. 2 illustrates an example mobile communication device displaying web content. Specifically, the GUI 113 of the mobile device 110 can display a web portal 160 exposing web content 150 or 155 of FIG. 1. In some implementations, the GUI 113 can display a web browser including the web portal 160. The web portal 160 can include sub-portions of web content 165, analogous to the sub-portions of web content 145 of FIG. 1, that are used to build the web portal 160.

The illustrated GUI 113 includes scroll bars 170 and 175 that facilitate navigation of the web portal 160 and the sub-portions of web content 165. Specifically, the GUI 113 has a height 180 and a width 185 (“GUI dimensions”) that defines the area for display of content thereon. In some implementations, the height 180 and the width 185 describe dimensional aspects of the web browser displayed by the GUI 113. Further, the web portal 160 has a height 190 and a width 195 (“web portal dimensions”) that can be larger than that of the GUI 113. For example, the height 190 of the web portal 160 can be greater than the height 180 of the GUI 113 and/or the width 195 of the web portal 160 can be greater than the width 185 of the GUI 113.

To that end, the web portal dimensions may typically be configured to be displayed upon a GUI of a larger screen device (e.g., a desktop or laptop computing device), such as the clients 135. Thus, to navigate the web portal 160 on the mobile device 110, the scroll bars 170 and 175 are implemented to provide scrolling of the web portal 160 to portions of the web portal 160 that are not currently displayed within the GUI 113. To that end, to facilitate navigation of the web portal 160 when the web portal is displayed by the GUI 113 of the mobile device 110, the web portal 160 can be focused such that contextually-relevant content of the web portal 160 is displayed by the GUI 113. Specifically, the web portal 160 can be focused such that a particular sub-portion of web content 165 is displayed by the GUI 113. The sub-portions of web content 165 include dimensions (e.g., a height and a width) that may be less than or equal to the GUI dimensions such that an entirety of a sub-portion of web content 165 are displayed within the GUI 113 at a time, described further below. To determine which of the sub-portions of web content 165 are displayed when the web portal 160 is focused, i.e., which sub-portions of web content 165 are contextually relevant to a user of the web portal 160, the user data 140 relating to the particular user of the web portal 160 is employed, described further below.

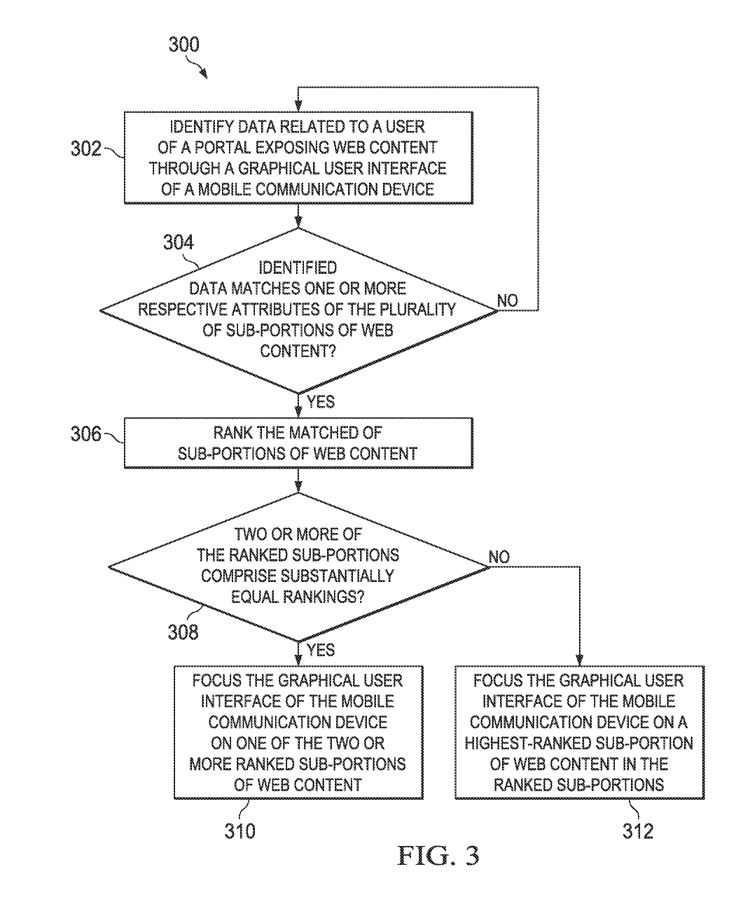

FIG. 3 illustrates an example method 300 for determining and focusing on contextually-relevant content in a mobile communication device. The example method 300 can be executed, for example, by the content focus module 104, using one or more computing devices. For example, any combination of the computing systems 102, 125 and the mobile device 110 can be used to execute the example process 300 and obtain any data from the memory of the mobile device 110, the computing systems 102, 125, the repository 130, and/or the clients 135.

Data is identified that relates to a user of a web portal exposing web content through a GUI of a mobile device (302). For example, a user of the web portal 160 can have associated user data 140. The user data 140 can include metadata concerning the user such as user specific data (e.g., relevant user roles, user seniority, line of business), user history, and user collaboration data, as described above. This metadata of the user data 140 can be identified. For example, the content focus module 104 can identify the metadata of the user data 140. Furthermore, the exposed web content can comprise the sub-portions of web content 165 and each of the sub-portions of web content 165 can comprise a self-contained Web document reference.

It is determined if the identified data matches one or more respective attributes of the sub-portions of web content of the web portal (304). For example, each sub-portion of web content 165 includes attributes describing the characteristics of the respective sub-portion of web content 165. To that end, the user data 140 (e.g., the user specific data, the user history, and the user collaboration data) can be compared to the attributes of the sub-portions of web content 165 to determine if the user data 140 matches attributes of any of the sub-portions of web content 165.

For example, the content focus module 104 can determine if the user data 140 matches the attributes of sub-portions of the web content 165. Furthermore, the attributes of each sub-portion of web content 165 can include metadata associated with each respective web content sub-portion 165. Thus, the metadata of the user data 140 can be compared to the metadata of the sub-portions of web content 165 to determine if the metadata of the user data 140 matches the metadata of one or more of the sub-portions of web content 165. The matching of the user data 140 with the sub-portions of web content 165 can provide a matching score. In some implementations, when a matching score between the metadata of the user data 140 and the metadata of the one or more of the sub-portions of web content 165 is above a threshold, the content focus module 104 deems the user data 140 and the sub-portions of web content 165 to be matched.

In some embodiments, metadata of the user data 140 and/or the metadata of one or more of the sub-portions of web content 165 may include a set of properties stored in a repository (such as a repository on a portal or other component of system 100 illustrated in FIG. 1). In some instances, properties of the user data 140 or one or more of the sub-portions of web content 165 may be relevant metadata, as they provide information on the nature of the sub-portion (e.g., type of hosted application, target roles in the organization). A portion of the content focus module 104 (e.g., a page builder component) may match properties of the sub-portions of web content 165 against properties of the user data 140, such as relevant roles, seniority, line of business, and other properties.

If it is determined that the identified data does not match at least one of the one more respective attributes of the sub-portions of web content of the web portal, the process returns to (302). For example, the content focus module 104 determines that the matching score between the user data 140 and each of the sub-portions of web content 165 is not greater than the threshold, and thus, the user data 140 is not deemed to match the sub-portions of web content 165.

If it is determined that the identified data matches at least one of the one more respective attributes of the sub-portions of web content of the web portal, the matched sub-portions of web content are ranked (306). For example, the content focus module 104 determines that the matching score between of the user data 140 and one or more of the sub-portions of web content 165 is greater than the threshold, and ranks the matched sub-portions of web content 165. To that end, the matched sub-portions of web content 165 are ranked based on the matching of the user data 140 to the attributes of the sub-portions of web content 165. In some embodiments, the matched sub-portions of web content 165 may be ranked based on the matching of the metadata of the user data 140 to the metadata of the sub-portions of web content 165. For example, the rankings can be based on the ranking score between the user data 140 and the metadata of the matched sub-portions of web content 165. The rankings can include any ranking system, for example, a number ranking or any ranking system suitable for ranking of the sub-portions of web content 165. Further, the sub-portions of web content 165 can be ranked from a highest-ranked sub-portion of web content 165 to a lowest-ranked sub-portion of web content 165.

It is determined if two or more ranked sub-portions of web content comprise substantially equal rankings (308). For example, the content focus module 104 can determine if two or more of the matched sub-portions of web content 165 can have substantially the same ranking score with respect to the user data 140. In such cases, each of the two or more matched sub-portions of web content 165 may be contextually-relevant to the user.

If it is determined that two or more ranked sub-portions of web content do comprise substantially equal rankings, a graphic user interface (GUI) of the mobile communications device is focused on one of the two or more ranked sub-portions of web content (310). For example, the content focus module 104 determines that two or more of the matched sub-portions of web content 165 can have substantially the same ranking score, and thus, one of the two or more ranked sub-portions of web content 165 having the same ranking score are presented to a user of the web portal 160 via the GUI 113 of the mobile device 110. The one or more ranked sub-portions of web content that is presented to the user can be selected randomly.

In some implementations, the two or more ranked sub-portions of web content 165 are presented to the user of the web portal 160 for selection by the user. For example, the user of the web portal 160 selects, via the GUI 113 of the mobile device 110 (e.g., the mobile device 110 includes an interactive touchscreen), a selection of one of the two or more ranked sub-portions of web content 165 having the same ranking score for display and focusing by the GUI 113. In some embodiments, the content focus module 104 may learn and/or gather additional user data based on receipt of such selections. For instance, the content focus module 104 may learn a user's preference for the content, type, and/or form of web content and apply this knowledge to future rankings Thus, in future instances of, for example, step (306), the content focus module 104 may rank particular sub-portions of web content 165 higher due to, for instance, previous selections made by the user.

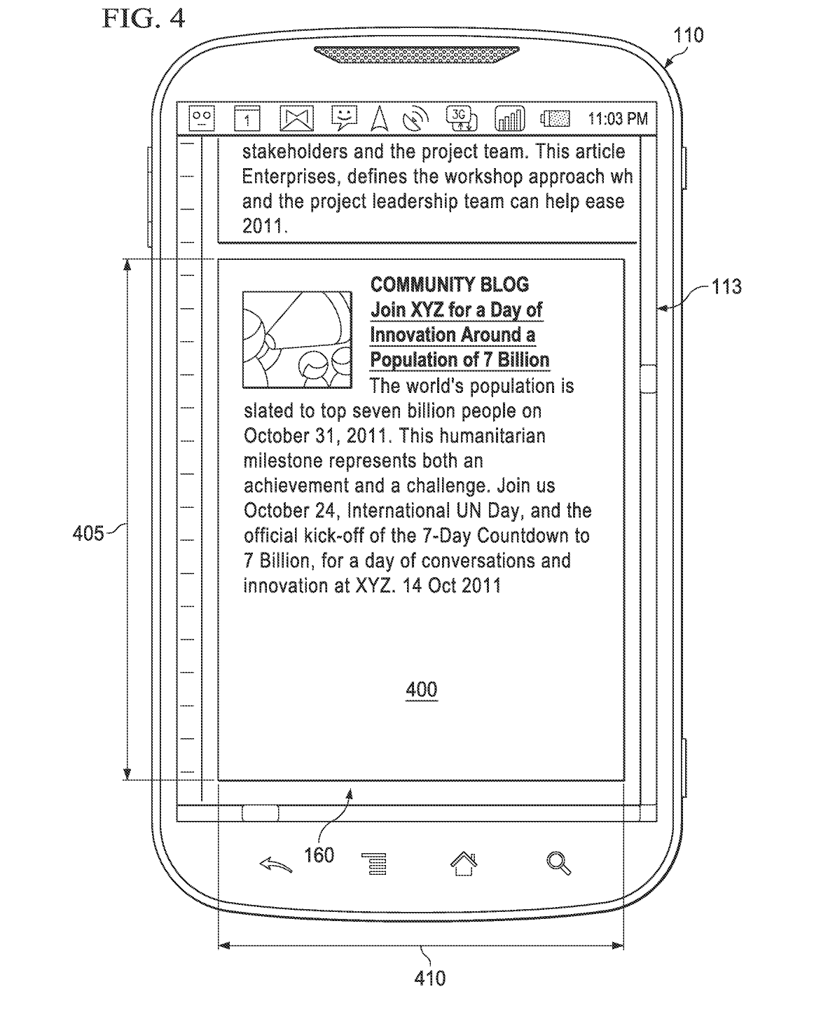

If it is determined that two or more ranked sub-portions of web content do not comprise substantially equal rankings, the graphic user interface (GUI) of the mobile communications device is focused on the highest-ranked sub-portion of web content in the ranked sub-portions of web content (312). For example, the GUI 113 of the mobile device 110 is focused on the highest-ranked sub-portions of web content 165 of the ranked sub-portions of web content 165, as shown in FIG. 4, discussed further below. In some implementations, focusing of the GUI 113 on the highest-ranked sub-portion of web content 165 can include zooming of the GUI 113 to enlarge the highest-ranked sub-portion of web content 165.

If it determined that two or more ranked sub-portions of web content do not comprise substantially equal rankings, the process continues to (312). For example, the content focus module 104 determines that none of the matched sub-portions of web content 165 have substantially the same ranking score. The GUI 113 of the mobile device 110 is then focused on the highest-ranked sub-portions of web content 165.

FIG. 4 illustrates an example mobile communication device displaying focused web content. Specifically, the GUI 113 of the mobile device 110 can display the web portal 160 including the highest-ranked sub-portion of web content 400. More specifically, the GUI 113 is focused on the highest-ranked sub-portion of web content 400. FIG. 4 illustrates the GUI 113, for example, after the method 300 is performed, i.e., after determining and focusing on contextually-relevant content (e.g., the sub-portion of web content 400) for display by the GUI 113 of the mobile device 110. This is in contrast to what is displayed by the GUI 113 with respect to FIG. 2. FIG. 2 illustrates the GUI 113 prior to the method 300 being performed, or as if the method 300 was not performed. Of course, additional methods for focusing a GUI of a mobile device on contextually-relevant web content according to the present disclosure may be implemented in addition to or in place of method 300. Specifically, FIG. 2 illustrates GUI 113 displays the web portal 160 (e.g., a portion thereof), while FIG. 4 illustrates GUI 113 displaying the highest-ranked sub-portion of web content 400.

The highest ranked web content sub-portion 400 includes a height 405 and a width 410. In some implementations, the height 405 and the width 410 are substantially the same, respectively, as the height 180 and the width 185 of the GUI 113. In some implementations, the height 405 and the width 410 are less than, respectively, the height 180 and the width 185 of the GUI 113. In some implementations, the height 405 and the width 410 are less than, respectively, the height 190 and the width 195 of the web portal 160.

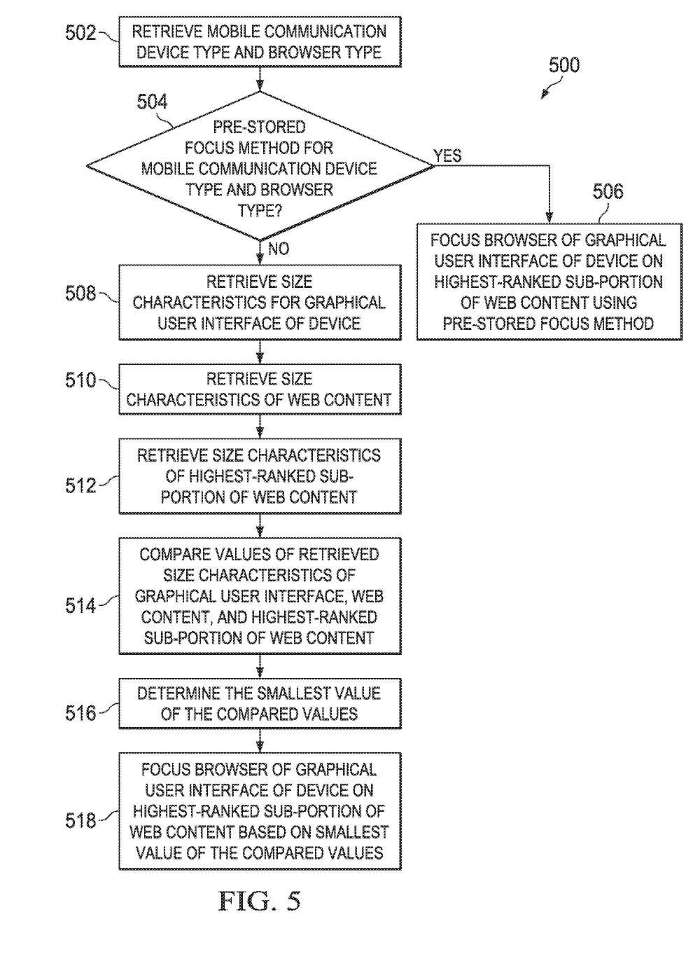

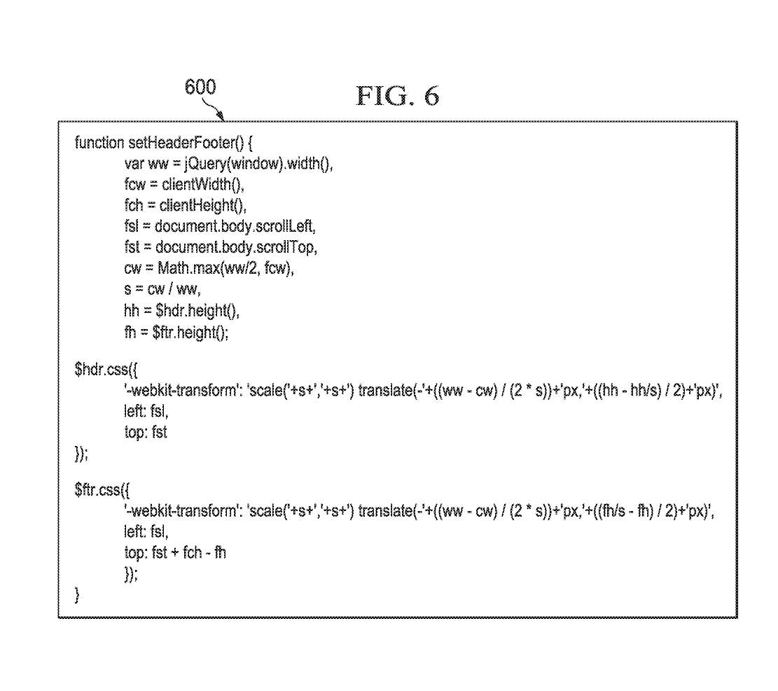

FIG. 5 illustrates an example method for focusing on contextually-relevant content in a mobile communication device. The example method 500 can be executed using one or more computing devices, by, for example, executing all or a portion of instructions 600 shown in FIG. 6. For example, any combination of the computing systems 102, 125 and the mobile device 110 can be used to execute the example process 500 and obtain any data from the memory of the mobile device 110, the computing systems 102, 125, the repository 130, and/or the clients 135.

A mobile communication device type and a browser type are retrieved (502). For example, the content focus module 104 can retrieve a type of the mobile device 110 and a type of browser displayed by the GUI 113 of the mobile device 110. The type of the mobile device 110 can include model type, operating system type, and other such features. The type of the browser can include a specific browser implemented on the mobile device 110 and version thereof (e.g., version 1, version 2, etc.).

It is determined if a method of focusing is pre-stored for the mobile communications device and the browser type (504). For example, the content focus module 104 can determine if the mobile device 110 includes a pre-stored method (e.g., stored by the memory of the mobile device 110) for focusing the web portal 160. This pre-stored method can be based on the type of the mobile device 110 and/or the browser type stored by the mobile device 110 or other criteria, such as, for example, user preset preferences or otherwise.

If it is determined that the method of focusing is pre-stored for the mobile communications device and the browser type, the browser of the graphical user interface (GUI) of the mobile communications device is focused on a highest-ranked sub-portion of web content using the pre-stored focus method (506). For example, the content focus module 104 determines that the mobile device 110 includes a pre-stored method for focusing the web portal 160. Thus, the mobile device 110 focuses the browser displayed by the GUI 113 to the highest-ranked sub-portion of web content 400 using the pre-stored focus method.

If it is determined that the method of focusing is not pre-stored for the mobile communications device and the browser type, the size characteristics for the GUI of the mobile communications device is retrieved (508). For example, the content focus module 104 determines that the mobile device 110 does not include a pre-stored method for focusing the web portal 160, and thus, the content focus module 104 retrieves the size characteristics of the GUI 113 (e.g., the “GUI dimensions”). The size characteristics of the GUI 113 can include the height 180 and the width 185 of the GUI 113.

The size characteristics of the web content are retrieved (510). For example, the content focus module 104 retrieves the size characteristics of the web portal 160 (e.g., the “web portal dimensions”). The size characteristics of the web portal 160 can include the height 190 and the width 195 of the web portal 160.

The size characteristics of the highest-ranked sub-portion of web content are retrieved (512). For example, the content focus module 104 retrieves the size characteristics of the highest-ranked sub-portion of web content 400. The size characteristics of the highest-ranked sub-portion of web content 400 can include the height 405 and the width 410 of the highest-ranked sub-portion of web content 400.

The values of the retrieved size characteristics of the GUI, the web content, and the highest-ranked sub-portion of web content are compared (514). For example, the content focus module 104 compares the size characteristics of the GUI 113 (the height 190 and the width 185), the size characteristics of the web portal 160 (the height 190 and the width 195), and the size characteristics of the highest-ranked sub-portion of web content 400 (the height 405 and the width 410). In some implementations, the content focus module 104 compares the size characteristics of the browser with the size characteristics of the highest-ranked sub-portion of web content 400.

The smallest value of the compared values is determined (516). For example, the content focus module 104 determines the smallest value of the compared values of the size characteristics of the GUI 133, the web portal 160, and the highest-ranked sub-portion of web content 400. In some implementations, the content focus module 104 determines the smallest value of the compared values of the size characteristics of the browser and the size characteristics of the highest-ranked sub-portion of web content 400.

The browser of the GUI of the mobile communications device is focused on the highest-ranked sub-portion of web content based on the smallest value of the compared values (518). For example, the browser of the GUI 113 of the mobile device 110 can be focused on the highest-ranked sub-portion of web content 400 based on the smallest value of the compared values. In some implementations, a display size of the highest-ranked sub-portion of web content 400 can be adjusted based on, at least, the size characteristics of the GUI 113 (e.g., the “GUI dimensions”) and the size characteristics of the highest-ranked sub-portion of web content 400. In some implementations, the display size of the highest-ranked sub-portion of web content 400 can be adjusted based on, at least, the size characteristics of the GUI 113 (e.g., the “GUI dimensions”), the size characteristics of the highest-ranked sub-portion of web content sub-400, and the size characteristics of the web portal 160 (e.g., the “web portal dimensions”).

A number of implementations have been described. Nevertheless, it will be understood that various modifications may be made. For example, other methods described herein besides those or in addition to that illustrated in FIGS. 3 and 5 may be performed. Further, the illustrated steps of methods 300 and 500 may be performed in different orders, either concurrently or serially. Further, steps may be performed in addition to those illustrated in methods 300 and 500, and some steps illustrated in methods 300 and 500 may be omitted without deviating from the present disclosure. Accordingly, other implementations are within the scope of the following claims.

What is claimed is:

1. A method performed with a computing system for managing content on a mobile communication device, the method comprising:
matching data associated with a user with one or more respective attributes of a plurality of sub-portions of web content, each of the plurality of sub-portions of web content comprising at least one attribute;
ranking the plurality of sub-portions of web content based on matching the data associated with the user with the one or more respective attributes of the plurality of sub-portions of web content; and
focusing the graphical user interface of the mobile communication device on a highest-ranked sub-portion of web content in the ranked plurality of sub-portions.

2. The method of claim 1, wherein ranking the plurality of sub-portions of web content comprises ranking the plurality of sub-portions of web content from a highest-ranked sub-portion of web content to a lowest-ranked sub-portion of web content.

3. The method of claim 1, further comprising:
exposing the web content through a graphical user interface of a mobile communication device, the exposed web content comprising the plurality of sub-portions of web content exposed through a portal;
identifying the data associated with the user.

4. The method of claim 3, wherein identifying the data associated with the user comprises identifying metadata associated with the related user data.

5. The method of claim 4, wherein the respective attributes of the plurality of sub-portions of web content comprise respective metadata associated with each of the plurality of sub-portions of web content, and
matching the identified data associated with the user with one or more respective attributes of the plurality of sub-portions of web content comprises matching the identified metadata associated with the related user data with the metadata associated with each of the plurality of sub-portions of web content.

6. The method of claim 1, wherein each of the plurality of sub-portions of web content comprise a self-contained Web document referenced by a Uniform Resource Locator (URL).

7. The method of claim 1, wherein focusing the graphical user interface of the mobile communication device on a highest-ranked sub-portion of web content in the ranked plurality of sub-portions comprises:
zooming the graphical user interface to enlarge the highest-ranked sub-portion of web content.

8. The method of claim 7, wherein zooming the graphical user interface to enlarge the highest-ranked sub-portion of web content comprises:
retrieving size characteristics of the graphical user interface;
retrieving size characteristics of the highest-ranked sub-portion of web content; and
adjusting a display size of the highest-ranked sub-portion of web content based, at least in part, on the size characteristics of the graphical user interface and the size characteristics of the highest-ranked sub-portion of web content.

9. The method of claim 8, further comprising:
retrieving size characteristics of the exposed web content; and
adjusting the display size of the highest-ranked sub-portion of web content based, at least in part, on the size characteristics of the graphical user interface, the size characteristics of the highest-ranked sub-portion of web content, and the size characteristics of the exposed web content.

10. The method of claim 9, wherein retrieving size characteristics of the graphical user interface comprises retrieving a browser width of the graphical user interface and a browser height of the graphical user interface, and
retrieving size characteristics of the highest-ranked sub-portion of web content comprises retrieving a sub-portion width and a sub-portion height.

11. The method of claim 10, further comprising:
comparing values for the browser width, the browser height, the sub-portion width, and the sub-portion height;
determining the smallest value of the compared values; and
adjusting the display size of the highest-ranked sub-portion of web content based, at least in part, on the determined smallest value.

12. An apparatus comprising instructions embodied on a tangible, non-transitory computer-readable media, the instructions operable when executed to cause a computing system to perform operations comprising:
matching data associated with a user with one or more respective attributes of a plurality of sub-portions of web content, each of the plurality of sub-portions of web content comprising at least one attribute;
ranking the plurality of sub-portions of web content based on matching the data associated with the user with the one or more respective attributes of the plurality of sub-portions of web content; and
focusing the graphical user interface of the mobile communication device on a highest-ranked sub-portion of web content in the ranked plurality of sub-portions.

13. The apparatus of claim 12, wherein ranking the plurality of sub-portions of web content comprises ranking the plurality of sub-portions of web content from a highest-ranked sub-portion of web content to a lowest-ranked sub-portion of web content.

14. The apparatus of claim 12, wherein the operations further comprise:
exposing the web content through a graphical user interface of a mobile communication device, the exposed web content comprising the plurality of sub-portions of web content exposed through a portal;
identifying the data associated with the user.

15. The apparatus of claim 14, wherein identifying the data associated with the user comprises identifying metadata associated with the related user data.

16. The apparatus of claim 15, wherein the respective attributes of the plurality of sub-portions of web content comprise respective metadata associated with each of the plurality of sub-portions of web content, and
matching the identified data associated with the user with one or more respective attributes of the plurality of sub-portions of web content comprises matching the identified metadata associated with the related user data with the metadata associated with each of the plurality of sub-portions of web content.

17. The apparatus of claim 12, wherein each of the plurality of sub-portions of web content comprise a self-contained Web document referenced by a Uniform Resource Locator (URL).

18. The apparatus of claim 12, wherein focusing the graphical user interface of the mobile communication device on a highest-ranked sub-portion of web content in the ranked plurality of sub-portions comprises:
zooming the graphical user interface to enlarge the highest-ranked sub-portion of web content.

19. The apparatus of claim 18, wherein zooming the graphical user interface to enlarge the highest-ranked sub-portion of web content comprises:
retrieving size characteristics of the graphical user interface;
retrieving size characteristics of the highest-ranked sub-portion of web content; and
adjusting a display size of the highest-ranked sub-portion of web content based, at least in part, on the size characteristics of the graphical user interface and the size characteristics of the highest-ranked sub-portion of web content.

20. The apparatus of claim 19, wherein the operations further comprise:
retrieving size characteristics of the exposed web content; and
adjusting the display size of the highest-ranked sub-portion of web content based, at least in part, on the size characteristics of the graphical user interface, the size characteristics of the highest-ranked sub-portion of web content, and the size characteristics of the exposed web content.

21. The apparatus of claim 19, wherein retrieving size characteristics of the graphical user interface comprises retrieving a browser width of the graphical user interface and a browser height of the graphical user interface, and
retrieving size characteristics of the highest-ranked sub-portion of web content comprises retrieving a sub-portion width and a sub-portion height.

22. The apparatus of claim 21, wherein the operations further comprise:
comparing values for the browser width, the browser height, the sub-portion width, and the sub-portion height;
determining the smallest value of the compared values; and
adjusting the display size of the highest-ranked sub-portion of web content based, at least in part, on the determined smallest value.

23. A computing system, comprising
one or more memory modules;
one or more processors;
a graphical user interface; and
instructions stored on one or more of the memory modules and operable when executed with the one or more processors to perform operations comprising:
matching data associated with a user with one or more respective attributes of a plurality of sub-portions of web content, each of the plurality of sub-portions of web content comprising at least one attribute;
ranking the plurality of sub-portions of web content based on matching the data associated with the user with the one or more respective attributes of the plurality of sub-portions of web content; and
focusing the graphical user interface of the mobile communication device on a highest-ranked sub-portion of web content in the ranked plurality of sub-portions.

24. The system of claim 23, wherein ranking the plurality of sub-portions of web content comprises ranking the plurality of sub-portions of web content from a highest-ranked sub-portion of web content to a lowest-ranked sub-portion of web content.

25. The system of claim 23, wherein the operations further comprise:
exposing the web content through a graphical user interface of a mobile communication device, the exposed web content comprising the plurality of sub-portions of web content exposed through a portal;
identifying the data associated with the user.

26. The system of claim 25, wherein identifying the data associated with the user comprises identifying metadata associated with the related user data.

27. The system of claim 26, wherein the respective attributes of the plurality of sub-portions of web content comprise respective metadata associated with each of the plurality of sub-portions of web content, and
matching the identified data associated with the user with one or more respective attributes of the plurality of sub-portions of web content comprises matching the identified metadata associated with the related user data with the metadata associated with each of the plurality of sub-portions of web content.

28. The system of claim 23, wherein each of the plurality of sub-portions of web content comprise a self-contained Web document referenced by a Uniform Resource Locator (URL).

29. The system of claim 23, wherein focusing the graphical user interface of the mobile communication device on a highest-ranked sub-portion of web content in the ranked plurality of sub-portions comprises:
zooming the graphical user interface to enlarge the highest-ranked sub-portion of web content.

30. The system of claim 29, wherein zooming the graphical user interface to enlarge the highest-ranked sub-portion of web content comprises:
retrieving size characteristics of the graphical user interface;
retrieving size characteristics of the highest-ranked sub-portion of web content; and
adjusting a display size of the highest-ranked sub-portion of web content based, at least in part, on the size characteristics of the graphical user interface and the size characteristics of the highest-ranked sub-portion of web content.

31. The system of claim 29, wherein the operations further comprise:
retrieving size characteristics of the exposed web content; and
adjusting the display size of the highest-ranked sub-portion of web content based, at least in part, on the size characteristics of the graphical user interface, the size characteristics of the highest-ranked sub-portion of web content, and the size characteristics of the exposed web content.

32. The system of claim 31, wherein retrieving size characteristics of the graphical user interface comprises retrieving a browser width of the graphical user interface and a browser height of the graphical user interface, and
retrieving size characteristics of the highest-ranked sub-portion of web content comprises retrieving a sub-portion width and a sub-portion height.

33. The system of claim 32, further comprising:
comparing values for the browser width, the browser height, the sub-portion width, and the sub-portion height;
determining the smallest value of the compared values; and
adjusting the display size of the highest-ranked sub-portion of web content based, at least in part, on the determined smallest value.
